(19) United States
(12) Patent Application Publication
(10) Pub. No.: US 2003/0103413 A1
(43) Pub. Date: Jun. 5, 2003

(54) Portable universal interface device

(76) Inventors: James J. Jacobi JR., St. Augustine, FL (US); Barbara Jacobi, St. Augustine, FL (US); Robert J. Mazzucchelli, Rowayton, CT (US)

Correspondence Address: Barry G. Magidoff, Esq., GREENBERG TRAURIG, LLP, 21st Floor, 885 Third Avenue, New York, NY, 10022, US

(21) Appl. No.: 09/998,501

(22) Filed: Nov. 30, 2001

(51) Int. Cl. G04B 47/00

(52) U.S. Cl. 368/10

(57) ABSTRACT

A portable universal interface device comprising a base housing and interchangeable interface component removably coupled to the base housing to allow the device to operate as one or more portable communication devices such as cell phones, MP3 players, E-mail transmittal and retrieval device, stored-value cards, remote control devices for locking cars, remote control devices for operating automatic garage door openers. The device operates as one or more portable communication devices depending on which interchangeable interface component of a plurality of interchangeable interface components is mounted within the base housing.

### BACKGROUND OF THE INVENTION

1. Field of the Invention

The present invention generally relates to a portable communication device that can convey information to various systems and operate in accordance with different protocols.

2. Description of the Related Art

Portable communication devices such as cell phones, Personal Digital Assistants (PDA's), pagers and laptop computers with wireless modems are ubiquitous. The use of such devices by the public has increased significantly in the last few years. Such communication devices are typically used to convey (i.e., transmit and/or receive) information in the form of audio, text and/or video. There is a second type of commonly used communication devices that is used in cases where the information being received and/or transmitted by such devices is exchanged between them without a user having to provide the information to be transmitted and/or received. The information is typically one or more digital codes or block of digital data representing a particular command or set of commands that are transmitted and/or received by the devices. Examples of such devices are remote controls for automatic garage door openers, television remote controls, remote control devices for cable boxes, stereo equipment, VCRs, DVD players, as well as remote control devices that control a plurality of electronic “home entertainment” devices. Also, other examples of remote control devices include remote control devices for household alarm systems, remote control devices for locking and unlocking vehicles of all types and remote sensing and reading devices that can read a household's water usage, power usage from a location near the house.

A third type of communication device is more passive in character in that such devices typically have information stored in some medium (e.g., magnetic strip, bar code strip, Read-Only Memory (ROM) semiconductor circuit or chip, Random Access Memory (RAM) semiconductor chip) whereby such stored information can be read and/or modified by some other device or system. Some examples of such passive communication devices include credit cards, Automated Teller Machine (ATM) cards, any surface having a readable bar code (e.g., Universal Product Code (UPC)) and Electronic Identification cards that use backscatter technology or Radio Frequency (RF) signals to convey identification information when prompted by an external system or device. Examples of Electronic Identification cards include cards or sets of cards that provide authorized individuals access to certain locations within a building. A carrier of the card usually positions it near an electronic black box having a visual indicator such as a Light Emitting Diode (LED) that switches colors (e.g., from red to green) and also generates an audible tone lasting a few seconds indicating that access is granted. The system then electromechanically unlocks a door or in some other way provides the carrier of the card access to a location that is otherwise inaccessible to anyone else who does not have the appropriate card. Another example of Electronic ID cards are systems which provide vehicles, approaching a toll booth on a highway, permission to proceed through the toll booth once a card or some other device located in the car is remotely read and verified by the system. The verification includes the confirmation by the system that the user of the card has sufficient funds in an account to pay the toll. In a similar manner, Electronic ID cards with magnetic strips are used in many mass transportation systems where users of such system purchase stored-value cards where a certain amount of funds is pre-paid that allows the users to have access to the transportation system once the card is swiped into a magnetic strip reading device installed at public transportation terminals, buses or even trolley cars. The stored value is reduced by the amount of the toll or fare automatically after each “transaction.” Also, the stored value is increased after every additional amount of funds has been pre-paid to the card (i.e., the card's account).

With increased popularity and increased demand for wireless communication devices, there now exist protocols for data wireless networks complying with Blue Tooth and Wi-Fi (IEEE 802.11 standard) protocols, that enable household devices (e.g., refrigerators, toasters, microwave ovens, cordless telephones, desktop computers, printers) to communicate with each other and with portable communication devices such as cell phones and wireless modems over wireless communication channels within a household, within an office environment or in some other defined environment. A protocol is a set of rules that dictates how communication devices communicate with each other. The information being conveyed between and among communication devices is processed, arranged, formatted and transmitted or received as per the protocol. Protocols are derived from standards established by standards bodies, industry organizations and/or governmental regulatory agencies to allow different manufacturers of commonly used communication devices to design devices that can communicate with each other.

Portable communication devices such as the ones described above are used for different purposes, follow or comply with different protocols and thus are not interchangeable. Therefore, users of such portable devices are often inconvenienced in that they have to carry several different devices for different purposes, which then require either attaching these devices on their person or storing them in multiple carrying cases making it more cumbersome to transport these devices. A further disadvantage with carrying several different devices is that the likelihood of misplacing or losing such devices is increased. For example, it is not unusual for a user to be simultaneously carrying the following: a cellular phone for voice communications; a pager; a wireless device for transmitting and retrieving e-mails; a PDA for storing important names, addresses, telephone numbers and dates of scheduled events; several credit cards; one or more ATM and stored-value cards, an electronic ID card for gaining access to the user's place of business and a remote control device for locking and unlocking the user's car. In addition to the increased likelihood of misplacing or losing one of the portable communication devices listed above, there is also an increased likelihood-given the number of different types of devices—that a user will forget to carry one or more of such devices rendering the user incapable of using the services provided by the forgotten devices.

What is therefore needed is a portable communication device that can be used to communicate with various systems and/or devices.

### SUMMARY OF THE INVENTION

The present invention provides a portable universal interface device comprising a base housing and an interchangeable interface component removably coupled to the base housing wherein the interface component contains circuitry capable of transmitting and/or receiving information in accordance with at least one protocol and process such information based on the at least one protocol. Information is transmitted and/or received over one or more communication media to or from at least one external device or system. Information is also transmitted and/or received through direct coupling of the interface component to an external device or system. The interface component further contains peripheral devices which it activates based on the received and/or transmitted information and such activated peripheral devices generate, for example, audio, visual, text signals, mechanical vibration or any other signals that are discernable by a user of the portable universal interface device. Depending on the protocol being used, at least one of a plurality of interchangeable interface components can be selected and then removably coupled to the base housing to effect proper transmission and/or reception of the information and therefore cause the portable universal interface device to operate as one or more portable communication devices. Thus, the user can use different interface components removably coupled to the base housing for communication with different external devices and/or systems.

### BRIEF DESCRIPTION OF THE DRAWINGS

FIG. 1 shows front and side views of an interchangeable interface component and base housing of the portable universal interface device of the present invention implemented as a digital wristwatch;

FIG. 2 shows the interchangeable interface component being swiped—in the direction shown by the arrow-through a magnetic strip reading device;

FIG. 3 shows a block diagram of the circuitry contained on one or both sides of the interface component;

FIG. 4 shows the views of FIG. 1 with the interchangeable interface component removably mounted in the base housing of the portable universal interface device of the present invention;

FIG. 5 shows an exploded perspective view of a portable communication device assembly having a portable universal interface device module of the present invention.

### DETAILED DESCRIPTION

The present invention provides a portable universal interface device comprising a base housing and an interchangeable interface component removably coupled to the base housing wherein the interface component contains circuitry capable of transmitting and/or receiving information in accordance with at least one protocol and processing such information based on the at least one protocol. Information is transmitted and/or received over one or more communication media to or from one or more external devices or systems. Information is also transmitted and/or received through direct coupling of the interface component to an external device or system. The removable interface component is interchangeable in that different types of removable interface components can be mounted in the base housing. The interchangeable removable interface component further contains peripheral devices which it activates based on the received and/or transmitted information and such activated peripheral devices, generate, for example, audio, visual, text signals, mechanical vibration signals or any other signals that are discernable by a user of the portable universal interface device. Some or all of the peripheral devices may be mounted on or within the base housing.

Depending on the protocol being used, at least one of a plurality of interchangeable interface components can be selected and then removably coupled to the base housing to effect proper transmission and reception of the information and therefore cause the portable universal interface device to operate as one or more portable communication devices. Thus, the user can use different interchangeable interface components removably coupled to the base housing for communication with different external devices and/or systems. External devices are any of different types of portable communication devices that can convey information in accordance with one or more protocols. Systems are any devices or set of interconnected devices that are part of a communication network that conveys information in accordance with one or more protocols.

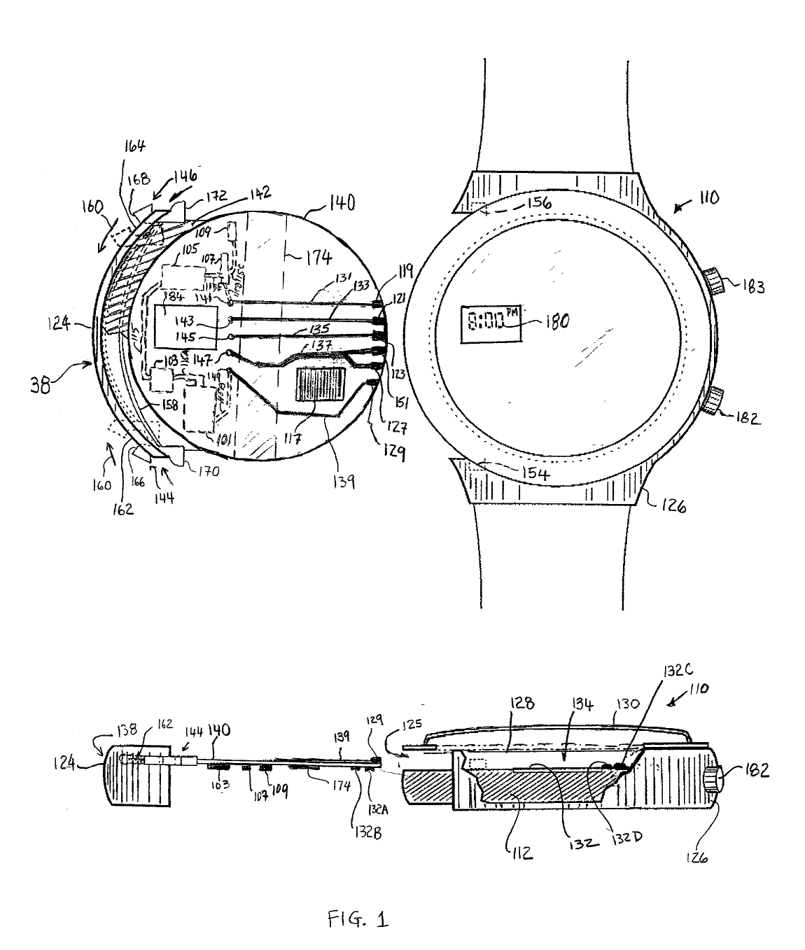

Referring to FIG. 1 there is shown the portable universal interface device of the present invention implemented as a digital wristwatch. It will be readily understood that the device of the present invention can be configured in various embodiments. The device of the present invention is certainly not limited to be configured as a digital wristwatch; indeed the device of the present invention can be integrated in the structure of any well known portable communication device including but not limited to a cellular phone, a PDA, a digital camera, a pager, a laptop PC, a notebook PC, an Electronic ID card, an MP3 player or any of several different types of remote control devices. In cases where the device of the present invention is integrated in the structure of a portable communication device, the base housing is part of the structure of the portable communication device. Further, the portable universal interface device of the present invention can be configured as a separate distinct device that is not integrated with or is not part of any other device. The structure and mechanical operation of the digital wristwatch of FIG. 1 are substantially similar to the digital watch disclosed in U.S. Pat. No. 5,793,710, which is incorporated herein by reference. It will be readily understood that the portable universal interface device of the present invention can also be implemented as an analog watch similar to that shown in U.S. Pat. No. 5,793,710.

The portable universal interface device of the present invention as shown in FIG. 1 comprises removable rim assembly 138 which includes removable rim portion 124 and a flange 142 attached to removable rim portion 124 for attachment to a removable face 140. Preferably, face 140 is fixed to flange 142 on removable rim assembly 138 to form a one-piece interchangeable unit. The portable universal interface device of the present invention further comprises a watch body 110 to which interchangeable removable rim assembly 138 is removably attached. A user of the portable universal interface device of the present invention selects an interchangeable removable rim assembly from a plurality of removable rim assemblies and removably attaches the selected removable rim assembly to watch body 110 thereby allowing the portable universal interface device to operate in substantially the same manner as one or more particular portable communication devices. Therefore, when the portable universal interface device is implemented as the digital wristwatch shown in FIG. 1, the base housing is watch body 110 and the interchangeable interface component is removable rim assembly 138.

Still referring to FIG. 1, face 140 is a substantially circular disk made of material having a dielectric constant and/or properties substantially similar to printed circuit boards. It will be readily understood, however, that face 140 can be of any shape (e.g., rectangular, square, triangular, oval) that is appropriate for the particular shape and construction of the watch body or other base housing. Preferably, face 140 is made from fiber and/or epoxy material. Face 140 contains electrical circuitry consisting of surface mounted semiconductor chips electrically connected to each other and to electrical components. The electrical circuitry may also contain electro-optic components and/or electromechanical components. The components of the electrical circuitry are electrically connected to each other with metallic traces (or lands) that are adhered onto face 140 through the well-known processes of electroplating and/or chemical etching. Certain components and/or circuits may also be connected to each other with optical pathways made from optical fibers for exchanging optical signals. Face 140 is shown having circuit components mounted on its oppositely facing surface (components and traces are in dashed line). The traces on the oppositely facing surface terminate at plated through vias (or feedholes) 141, 143, 145, 147, 149 from which traces 131, 133, 135, 137, 139 emanate and finally terminate at fingers 119, 121, 123, 151, 127, 129 respectively. The fingers are electrical terminations that enable electrical signals and/or electrical power to be exchanged between the circuitry mounted on face 140 and any additional circuitry disposed within watch body 110. The fingers engage a female connector assembly (not shown) suitably mounted in watch body 110.

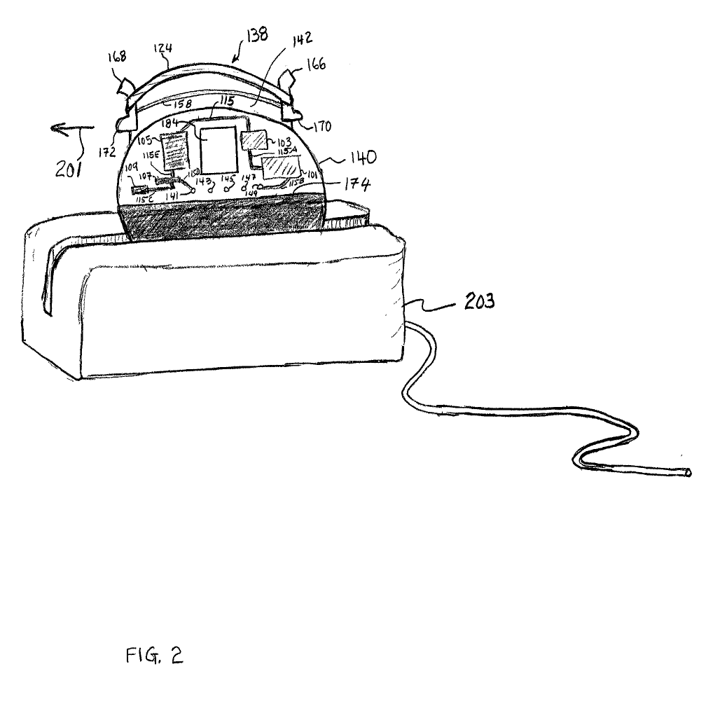

Face 140 also has a strip 117 of bar code information mounted thereon and a window 184 through which display 180 is viewed. Display 180 can be a liquid crystal display (LCD), an LED display or any other well-known display device. Also mounted on the oppositely facing surface of face 140 is magnetic strip 174 (shown in dashed lines) on which various information can be stored to allow the portable universal interface device of the present invention to operate as an electronic ID card. A bar code reader or scanner can read strip 117 again allowing the present invention to operate as an electronic ID card. Referring to FIG. 2 momentarily, there is shown removable rim assembly 138 being swiped in magnetic strip reader 203 in the direction of arrow 201 to allow magnetic strip reader 203 to read all or a portion of the information stored in magnetic strip 174. FIG. 2 represents a situation where the interchangeable interface component (i.e., removable rim assembly 138) is directly coupled to an external device or system.

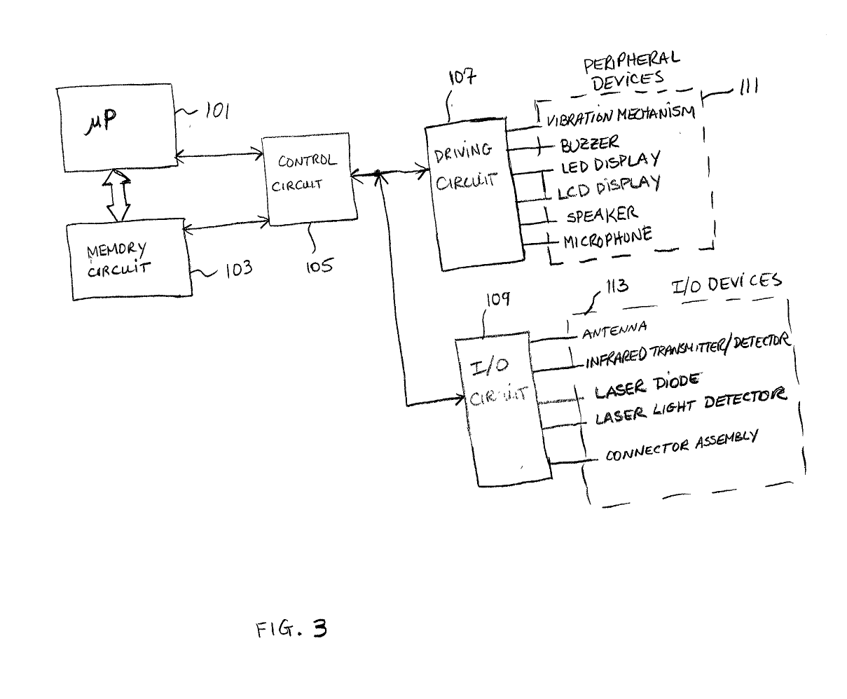

Referring now to FIG. 3, the electrical circuitry mounted on face 140 is shown. The electrical circuitry comprises microprocessor 101 coupled to Control circuit 105. Memory circuit 103 is coupled to microprocessor 101 and control circuit 105. Memory circuit 103 comprises RAM circuits, ROM and/or magnetic media from which stored information can be read and transmitted or on which received information can be stored upon reception or stored after having been processed by microprocessor 101. Control circuit 105 is coupled to driving circuit 107 and I/O circuit 109. Some of the traces interconnecting the devices mounted on face 140 are shown as traces 115 and 115A-115E in FIGS. 1, 2 and 4.

Driving circuit 107 typically contains the circuitry used to generate user discernible signals with the use of various peripheral devices. Peripheral devices 111 comprising a vibration mechanism, a buzzer, an LED display, an LCD display, a speaker or connection for an external earpiece or head phone and a microphone are some examples of the different types of peripheral devices that can be mounted on face 140 or within watch body 110. It will be readily understood that other types of peripheral devices that can generate user discernable signals can also be used with the present invention. User discernible signals are signals that a person can detect or perceive through any one or more senses such as smell, taste, sight, touch or feel and hearing. Examples of user discernible signals include text messages to an LCD, videos or still images shown on an LCD, turning on or off an LED, causing the portable device to vibrate with the vibration mechanism, generating an audible signal with a buzzer or similar device or even the circuitry to operate a speaker located within the watch body or an ear phone that can be connected to the watch body via a mating connection (not shown) at the periphery of the watch body. The microphone can be used by the user to store short audio messages. In particular, a headset connected to the speaker input can be used with the microphone to operate the portable universal interface device as a cellular phone. A larger display or an additional display along with a plurality of miniature buttons mounted on face 140 and protruding though apertures of a special detachable outer crystal 130 (not shown) can be used to operate the cellular phone. A display encompassing one entire side of face 140 can be provided so that different areas of the display can be used to convey different types of information; outer crystal 130 can be detachable to allow this use of the portable universal interface device. Using the same configuration for the cell phone just described, the portable universal interface device can also operate as an E-mail transmittal and retrieval device. In another embodiment, the cellular phone can be designed to operate through a voice activated and voice recognition system. Such a system is realized through appropriate digital signal processing hardware and software under the control of the microprocessor that allows a user to operate the portable universal interface device as a cellular phone with the use of voice commands.

I/O circuit 109 contains the circuitry to operate any one of I/O devices 113 that transmit and/or receive signals from external devices and/or systems. For example, I/O circuit 109 can provide the proper signals to an antenna mounted on face 140 or mounted in watch body 110 to transmit and/or receive wireless radio signals to or from one or more external devices and/or systems. Similarly, a LASER (Light Amplification by Stimulated Emission of Radiation) light transmitter and detector, an infrared transmitter and detector, or a mechanical connection assembly for transmitting and receiving electrical and/or optical signals are provided to allow the portable universal interface device of the present invention to exchange information with one or more external devices and/or systems. The mechanical connection assembly can be a connector assembly (preferably female) mounted onto watch body 110 (i.e., the base housing) or on interchangeable removable rim portion 138 (i.e., interchangeable interface component). When mounted on interchangeable removable rim portion 138, the connector assembly allows a direct connection between an external device or system and the interchangeable removable rim 138; in such a case the connection can be made while interchangeable removable rim 138 is mounted within watch body 110 or is totally uncoupled to watch body 110. For clarity and simplicity of illustration, none of the I/O devices and peripheral devices listed in FIG. 3 is shown in FIG. 1. It will be readily obvious to one skilled in the art to which this invention belongs that all or part of the circuitry shown in FIG. 3 can be mounted in watch body 110 or any base housing.

Referring back to FIG. 1, watch body 110 has digital watch mechanism 112 disposed therein. Watch mechanism 112 also includes a pair of actuating buttons 182, 183 used for setting the mechanism 112 in the manner known for conventional digital timepieces. Actuating members 182 and 183 are also used to operate the interface component (e.g., removable rim assembly 138). For example, once a particular removable rim assembly is inserted in watch body 110 to implement a remote control for an automatic garage door opener, the user of such a device simply has to press actuating members 182 and 183 simultaneously press or pull both members (or pull or press one actuating member independently of the other) to activate the remote control. Other specific sequence of actions with actuating members 182 and 183 can be devised to operate the various versions of the portable universal interface device of the present invention. Additional actuating members can be provided to facilitate the operation of the portable universal interface device.

Additional electrical connections between interchangeable removable rim assembly 138 and watch body 110 are implemented with mating connectors 132A and 132B on one side of face 140 and 132C and 132D on surface 132 of mechanism 112. An outer transparent crystal (or glass) cover 130 is used. As is described above, the portable universal interface device of the present invention is able to transmit and/or receive laser signals, signals from LED's, signals from bar code scanning devices and other optical signals. A glass cover having certain physical qualities is chosen such that it does not unduly affect any optical signal being transmitted and/or received by the device of the present invention. An optional inner transparent cover 128 spaced above surface 132 is included to define face compartment 134. Non-removable rim portion 126 has an opening or slot 125 through which face 140 is inserted so as to reside in compartment 134 and which slot is normally closed by the removable rim portion 124. The removal and insertion of removable rim assembly 138 to or from watch body 110 are done as per the proper manipulation of tabs 144, 146 having hook members 168, 172 and 166, 170 respectively and spring 158 bent so that tabs 144, 146 move in the direction shown by arrows 160 to engage or disengage their hook members to or from the recesses 154, 156 of non-removable rim portion 126 as described in U.S. Pat. No. 5,793,710.

The signals provided by I/O circuit 109 originate from memory circuit 103 via microprocessor 101 and/or originate from microprocessor 101 itself. Microprocessor 101 is understood to include digital signal processing (DSP) circuits or perform DSP functions such as digital filtering and voice coding and decoding. Protocol data containing instructions dictating the format of transmitted and received information and how such information is to be conveyed to external devices and/or systems are obtained from memory circuit 103 by microprocessor 101. Microprocessor 101, in concert with control circuit 105 generate the timing signals to transfer protocol dictated information to I/O circuit 109 which enables such information to be conveyed via one or more of the I/O devices. A crystal oscillator or some other well-known oscillating circuit (not shown) preferably located within watch body 110 can serve as the basic clock signal for the microprocessor and control circuitry. The actual information that is transmitted also originates from memory circuit 103. Information received from external devices and/or systems are first processed by microprocessor 101 and, if necessary, microprocessor 101 stores the processed received information in memory circuit 103. Received information may be stored directly in memory 103 without first being processed by microprocessor 101.

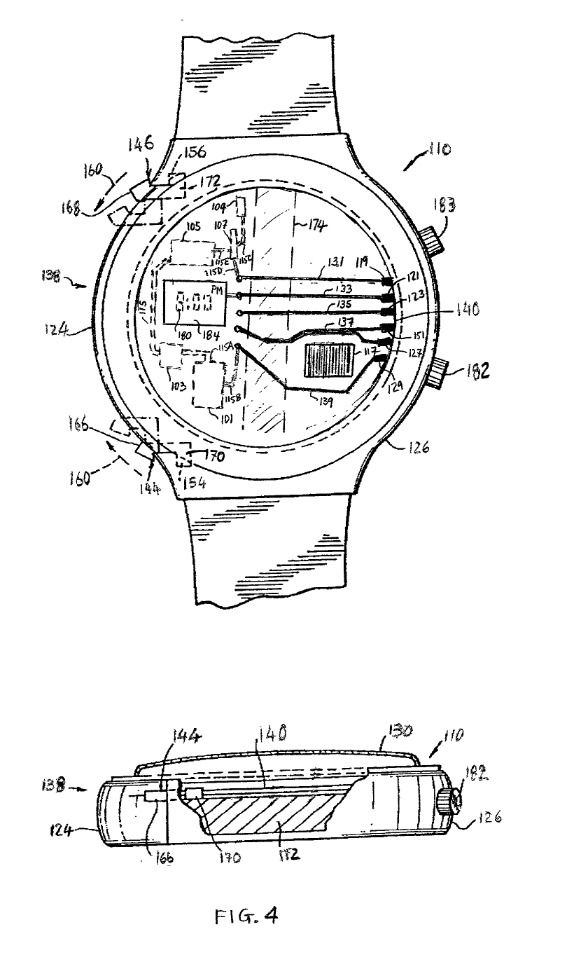

Referring now to FIG. 4, there is shown the portable universal interface device of the present invention implemented as a digital wristwatch with the interchangeable removable rim assembly 138 removably mounted in watch body 110. The operation of the portable universal interface device simply involves the insertion of the proper interchangeable removable rim assembly (138) into watch body 110 and manipulating one or more actuating members (or providing suitable voice commands).

The user of the portable universal interface device has several interchangeable removable rim assemblies (i.e., several interchangeable interface components), which are stored in a protective portfolio like case similar to those used for storing business cards or a carrying case similar to pocket organizers or billfolds. Each interchangeable removable rim assembly can be uniquely marked or labeled in some manner to allow the user to quickly and easily discern correctly the particular function of that interchangeable removable rim assembly. The functions are the particular capabilities of an interchangeable interface component (e.g., removable rim assembly 138) mounted in the watch body to allow the portable universal interface device of the present invention to operate as one or more particular portable communication devices. The interchangeable removable rim assemblies can be color coded where each color represents one or more particular functions. For example, an interchangeable removable rim assembly with a yellow sticker represents an MP3 player function. The user first downloads MP3 format music files onto the portable universal interface device (with proper interchangeable removable rim assembly) from a computer. Prior to downloading, the user mounted an interchangeable removable rim assembly, which has the proper female connector assembly for receiving the music data from a parallel or USB (Universal Serial Bus) port of a computer. A USB cable or parallel port cable is used to connect the device to the computer. The female connector assembly can also be located on the watch body (110); in such a case the interchangeable removable rim assembly will be constructed to receive the information from the computer through some internal connection between the female connector and the interchangeable removable rim assembly. In another embodiment, the music files from the computer can be downloaded wirelessly to the portable universal interface device of the present invention. The wireless transfer of information can be done, for example, in accordance with wireless LAN protocols such as Blue Tooth and/or Wi-Fi (to be discussed infra).

Once the user has finished downloading the desired music files, a headset or earpiece can be connected to another connector assembly (preferably female) that is part of the removable rim assembly to allow the user to operate the device as an MP3 player. Also, the LCD will describe in text the title of the music being played, the amount of playing time left and other pertinent information typically displayed by an MP3 player while playing music.

In a home environment, the portable user interface device can be used for various purposes. For example, with the proper interchangeable removable rim assembly mounted in the watch body, the portable universal interface device can be operated as a remote control device for an automatic garage door opener or a remote control device for television receivers, cable boxes or stereo receivers. While driving and upon approaching an automated toll booth, the user, while wearing the portable universal interface device configured as an electronic ID card for an automated highway toll system, positions his/her wrist to enable the traffic system to read the electronic ID card. At work, the portable universal interface device can be used by the user to park his/her car and electronically lock the car and arm the car alarm with the device of the present invention having the proper interchangeable removable rim assembly mounted within the watch body to enable the portable universal interface device to operate as a remote control device to arm and lock a parked vehicle. Further, at work the user can use the device of the present invention as an electronic ID card to gain entry to various locations at his/her place of business.

The above-described uses of the portable universal interface device of the present invention serve only as examples of the various functions of the portable universal interface device of the present invention. It will be readily understood that a particular interchangeable removable rim assembly can enable the device to operate as one or more different portable communication devices. For example, an interchangeable removable rim assembly can be constructed to cause the device of the present invention to operate as several different remote control devices and/or several different electronic ID cards. Therefore, a user need not have exchanged remote rim assemblies for each different portable communication device function he or she wishes to perform.

Depending on the interchangeable removable rim assembly (or interface component) mounted in the watch body (or base housing), the portable universal interface device of the present invention can also operate as a device that complies with the Wi-Fi protocol and/or the Blue Tooth protocol to allow the device to be part of a wireless LAN (Local Area Network). The memory circuit of the interchangeable removable rim assembly contains the proper Wi-Fi protocol instruction and proper Blue Tooth protocol instructions to allow the device to operate within and be part of a wireless LAN that complies with the Wi-Fi and/or Blue Tooth protocols. It will be readily understood that part or all of the protocols may be stored in memory located in the watch body (i.e., base housing). Also, the interchangeable removable rim assemblies can be designed to receive protocols (while mounted in the watch body) that are downloaded from an external source (e.g., computer system, communication system) via wireless communication channels or wired ports from a computer (e.g., USB cable, optical cable). The protocols can also be downloaded onto memory located in the watch body (i.e., base housing), which then uploads the protocol onto an interchangeable removable rim assembly mounted therein.

As previously stated, the portable universal interface device of the present invention can be integrated in the structure of any well-known portable communication device. The portable universal interface device and a portable communication device thus form a portable universal communication device assembly. The portable universal interface device can either be a module that can be detachably coupled to a portable communication device or the portable universal interface device can be permanently integrated within the physical structure of the portable communication device. In the case where the portable universal interface device is a detachable module, the manufacture and design of the portable communication device is such that it has a physical interface that allows the portable universal interface device of the present invention to couple to it. Further, not only will the coupled portable universal interface device be able to operate its own peripheral devices, but it will also be able to control any one or all of the peripheral devices of the portable communication device to which it is attached.

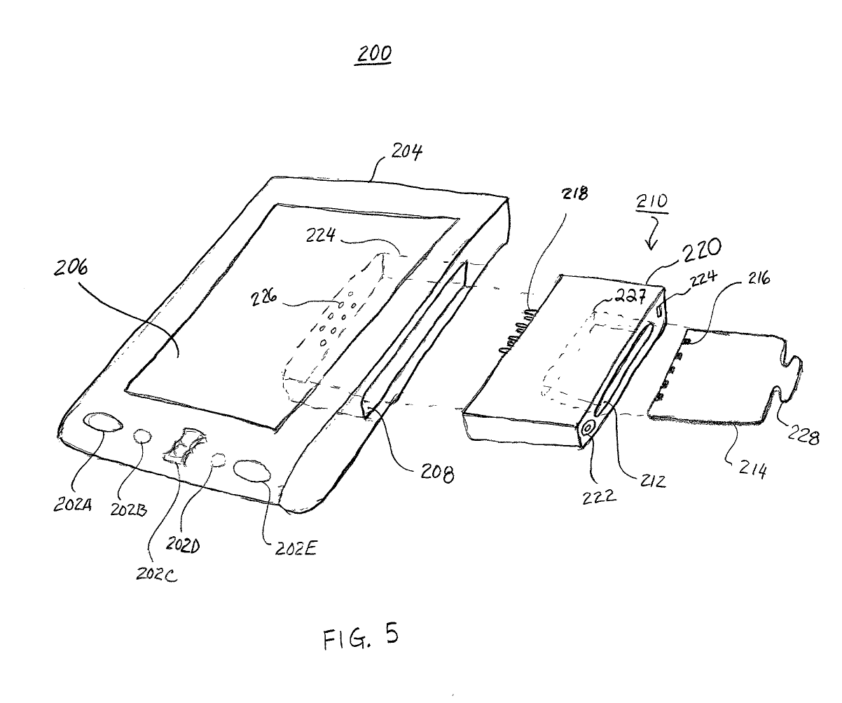

Referring now to FIG. 5, there is shown a portable universal communication device assembly 200 comprising PDA 204 to which portable universal interface device module 210 is detachably coupled. The assembly can use any well-known portable communication device; PDA 204 is used only for illustrative purposes. PDA 204 has an LCD 206 and operating buttons 202A-202E. PDA 204 further has a compartment 224 with entry slot 208 through which portable universal interface device module 210 is inserted and whose male pins 218 matingly engage female pins 226 in mating fashion. Male pins 218 and corresponding female pins 226 form a physical interface that allows signals to be exchanged between the portable universal interface device module 210 and PDA 204 to allow device 210 to control any one or all of the peripherals of PDA 204. For example, information received and/or stored within portable universal interface device module 210 can be displayed on LCD 206 because device 210 is able to operate LCD 206 through the physical interface. Also, again because of the physical interface, operating buttons 202A-202E can be used to perform various functions of device 210. Also, the physical interface may provide power to module 210 or module 210 may have its own source of power (e.g., one or more batteries).

Module 210 comprises base housing 220, peripheral devices 222 (female connector assembly for an earpiece or headset), and 224 (microphone) and physical interface consisting of male pins 218. Base housing 220 further has a compartment 227 with entry slot 212 through which interchangeable removable interface component 214 is inserted and removably coupled to base housing 220. Interchangeable removable interface component 214 contains circuitry similar to the circuitry mounted on face 140 of interchangeable removable rim assembly 138 of FIG. 1 discussed supra. For ease of illustration, the circuitry is not shown. Some or all of the circuitry mounted on interchangeable removable interface component 214 may be located in base housing 220. Interchangeable removable interface component 214 has fingers 216 that engage a female connector (not shown) within compartment 227. Interchangeable removable interface component 214 contains other peripheral devices (e.g., buzzer) and also contains I/O devices and associated circuitry and components similar to the circuitry and components of interchangeable removable rim assembly 138 discussed supra. Note also that interchangeable removable rim component 214 has handle 228 which allows for its easy insertion and/or removal to or from base housing 220.

Once base housing 220 is detachably mounted in PDA 204 forming portable universal communication device assembly 200, any one of a plurality of interchangeable removable interface components 214 can be removably inserted into the mounted base housing to allow assembly 200 to operate as different portable communication devices. Moreover, a particular interchangeable interface component 214 can be used in other assemblies having a detachably mounted (or permanently integrated) module 210. Therefore, the same interchangeable removable interface component 214 can be inserted and caused to operate different portable communication devices as long as those devices have base housings 220 mounted therein. Thus, interchangeable removable interface components 214 can migrate between and be used by different assemblies or similar assemblies as long as the assemblies have housings 220 mounted therein. The physical interface that allows signals to be exchanged between the module 210 and the portable communication device (e.g., PDA 204) can be standardized (i.e., physical interface based on a standard) to allow manufacturers to design and build different portable communication devices with uniform interfaces. Such a physical interface standard can, for example, assign certain types of signals to certain mating pin pairs 218, 226. It should be noted that the physical interface portion of the present invention is not limited to electrically conducting male pins 218 and corresponding female pins 226 as shown in FIG. 5. Other well-known arrangements for transferring electrical, mechanical and/or optical signals can be used. For example, connection assemblies serving as pathways for optical signals can also be part of the physical interface.

Interchangeable removable interface component 214 enables peripheral devices of the portable communication device (e.g., PDA 204) and peripheral devices of module 210 (not shown) to generate user discernable signals. Further, interchangeable removable interface component 214 allows a user of the portable universal communication device assembly to operate the assembly with actuating members and/or operating buttons (e.g., buttons 202A-202E) of the portable communication device.

With module 210 mounted and with the proper interchangeable removable interface component inserted, the assembly shown in FIG. 5 can be used as a cellular phone for example where the user uses microphone 224 and an earpiece (or headset) connected to female connector assembly 222 to transmit and/or receive audio signals. The same interchangeable removable interface device 214 can be used to operate another PDA (or other portable communication device) that has a base housing mounted therein. Operation of a portable communication device means manipulating actuating members or operating buttons of the portable communication device to cause such device to perform various functions. Also, information from one portable communication device can be transferred to another portable communication device by using a common interchangeable removable interface component to operate both devices.

The portable universal communication device assembly 200 can also be implemented with a digital or analog wristwatch similar in appearance and construction to the wristwatches disclosed in U.S. Pat. No. 5,793,710. In particular module 210 of FIG. 5 can be detachably mounted in a digital wristwatch similar in appearance and construction-but probably relatively larger in size—to the one shown in FIG. 1. Thus, any one of a plurality of interchangeable removable interface components 214 can be removably mounted in such an assembly to cause it to function as different portable communication devices. As with the assembly depicted in FIG. 5, the same interchangeable interface component 214 can be used to operate other watches having modules 210 mounted therein or operate any other portable communication devices having modules 210 mounted therein.

We claim

1. A portable universal interface device comprising:
a base housing; and
an interchangeable interface component removably coupled to the base housing whereby the interface component contains circuitry that transmit and/or receive information in accordance with at least one protocol and the interface component also contains peripheral devices that generate user discernible signals based on the transmitted and/or received information.

2. The portable universal interface device of claim 1 where the circuitry activates the peripheral devices based on transmitted and /or received information causing the peripheral devices to generate user discernable signals.

3. The portable universal interface device of claim 2 where the user discernible signals generated by the peripheral devices are audio signals, visual signals, text signals, or mechanical vibrations.

4. The portable universal interface device of claim 1 where the peripheral devices comprise a vibration mechanism, a buzzer, an LED display, an LCD display, a speaker and a microphone.

5. The portable universal interface device of claim 1 where the interface component has I/O devices, which are used to transmit and/or receive information.

6. The portable universal interface device of claim 5 where the I/O devices comprise an antenna, an infrared transmitter and detector, a LASER diode, a LASER light detector, and a connector assembly.

7. The portable universal interface device of claim 1 where the interface component further comprises a strip of bar code and/or a magnetic strip both of which contain information.

8. The portable universal interface device of claim 1 where the device operates as one or more portable communication devices.

9. The portable universal interface device of claim 1 where the base housing is a watch body of a digital watch and the interchangeable interface component is an interchangeable removable rim assembly having a printed circuit board on which all or part of the circuitry is located.

10. The portable universal interface device of claim 9 where part of the circuitry is located within the watch body.

11. The portable universal interface device of claim 9 where the I/O devices and the peripheral devices are located on the printed circuit board.

12. The portable universal interface device of claim 9 where at least one of the I/O devices and at least one of the peripheral devices are located on the watch body.

13. The portable universal interface device of claim 9 further comprising a watch mechanism disposed within the watch body and actuating members coupled to the watch mechanism to operate the watch mechanism where the actuating members are further used to operate the circuitry.

14. The portable universal interface device of claim 9 where different interchangeable removable rim assemblies enable the device to operate as different portable communication devices such as an MP3 player, a remote control device, a stored-value card, a cellular phone, a PDA, an E-mail transmittal and retrieval device, an ATM card and an electronic ID card.

15. The portable universal interface device of claim 9 where the memory circuit contains instructions to allow the device to operate as part of a wireless LAN that complies with the Blue Tooth protocol and/or Wi-Fi protocol.

16. The portable universal interface device of claim 1 where the base housing is a watch body of an analog watch and the interchangeable interface component is an interchangeable removable rim assembly having a printed circuit board on which all or part of the circuitry is located.

17. The portable universal interface device of claim 1 where the peripheral devices comprise an LCD on one entire side of the interchangeable interface component.

18. A portable universal communication device assembly comprising:
a portable communication device;
a portable universal interface device module detachably mounted to the portable communication device via a physical interface whereby the module comprises an interchangeable interface component removably coupled to a base housing thereby allowing the portable universal communication device assembly to operate as any one of a plurality of portable communication devices.

19. The portable universal communication device assembly of claim 18 where the physical interface is based on a standard.

20. The portable universal communication device assembly of claim 18 where the interchangeable removable interface component enables peripheral devices of the portable communication device to generate user discernable signals.

21. The portable universal communication device assembly of claim 18 where the interchangeable removable interface component enables peripheral devices of the portable universal interface device module to generate user discernable signals.

22. The portable universal communication device assembly of claim 18 where the interchangeable removable interface component enables a user to operate the portable universal communication assembly with actuating members or operating buttons of the portable communication device.

23. The portable universal communication device assembly of claim 18 where a particular interchangeable removable interface component is used to operate different portable communication devices having base housings mounted therein.

24. The portable universal communication device assembly of claim 18 where the portable communication device is a digital wristwatch.
